(19) United States
(12) Patent Application Publication
(10) Pub. No.: US 2013/0255335 A1
(43) Pub. Date: Oct. 3, 2013

(54) SYSTEMS AND METHODS FOR ELECTRONIC LOCKING DEVICE POWER MANAGEMENT

(71) Applicant: MASTER LOCK COMPANY, Oak Creek, WI (US)

(72) Inventor: Michael B. Jonely, Whitewater, WI (US)

(73) Assignee: MASTER LOCK COMPANY, Oak Creek, WI (US)

(21) Appl. No.: 13/830,600

(22) Filed: Mar. 14, 2013

Related U.S. Application Data
(60) Provisional application No. 61/616,869, filed on Mar. 28, 2012.

(51) Int. Cl. E05B 47/00

(52) U.S. Cl. CPC E05B 47/0001
USPC 70/277

(57) ABSTRACT

Electronic locking devices are provided. One electronic locking device includes a circuit configured to cause a processor of the electronic locking device to be powered by a capacitor, and not a battery for powering a high current load of the electronic locking device, while the battery is driving the high current load of the electronic locking device.

### CROSS REFERENCE TO RELATED APPLICATIONS

The present application claims the benefit of U.S. Provisional Patent Application Ser. No. 61/616,869, filed Mar. 28, 2012, titled “Systems and Methods for Electronic Locking Device Power Management,” which is hereby incorporated herein in its entirety.

### BACKGROUND

Certain batteries, e.g., thin coin cell batteries, can have a high internal resistance that render the batteries inefficient or ineffective in certain high current drain applications. An example of a high current drain application is a motor that locks/unlocks an electronic locking device, such as a padlock. Conventional systems and methods for powering high current drain motors require large electrical components that prohibitively increase the size and cost of devices.

### SUMMARY

One embodiment of the disclosure relates to an electronic locking device including a circuit configured to cause a processor of the electronic locking device to be powered by a capacitor, and not a battery for powering a high current load of the electronic locking device, while the battery is driving the high current load of the electronic locking device.

Another embodiment relates to an electronic locking device including a battery, a processor, a load, and a capacitor that is electrically coupled to the processor. The device further includes at least one switching device that is controllable by control signals received from the processor to place the at least one switching device in one of a plurality of configurations. In a first configuration, the at least one switching device is configured to electrically isolate the load from the battery and connect the battery to the capacitor to charge the capacitor. In a second configuration, the at least one switching device is configured to connect the load to the battery and electrically isolate the capacitor and the processor from the battery and the load. The processor is powered by the capacitor in the second configuration.

Another embodiment relates to an electronic locking device including a battery, a high current load, a processor, a capacitor, a first switch, and a second switch. The process is configured to control a position of the first switch and a position of the second switch. The capacitor is connected in parallel with the processor. The first switch is configured to connect, in a closed position, the battery to the capacitor and the processor. The battery provides power to the processor and the capacitor when the first switch is in the closed position. The first switch is configured to disconnect, in an open position, the battery from the capacitor and the processor. The capacitor is configured to provide power to the processor when the first switch is the open position. The second switch is configured to connect, in a closed position, the battery to the high current load. The battery provides power to the high current load when the second switch is in the closed position. The second switch is configured to disconnect, in an open position, the battery from the high current load. In some implementations, the first switch may be in an opposite position compared to the second switch.

Another embodiment of the disclosure relates to an electronic locking device. The electronic locking device includes a processor for providing logic of the electronic locking device, a high current load, a battery for powering the high current load, and a capacitor in parallel with the processor. The device further includes a circuit configured to cause the processor to be powered by the capacitor, and not the battery, while the battery is driving the high current load.

Another embodiment of the disclosure relates to an electronic locking device including a battery, a processor, a load, and a capacitor that is electrically coupled to a processor in a parallel configuration. The device further includes a first switch configured to electrically connect and disconnect the load to the battery based on one or more control signals received from the processor. The device further includes a second switch configured to electrically connect and disconnect the processor and the capacitor to the battery based on one or more control signals received from the processor. In a first mode, the processor is configured to close the first switch and open the second switch such that the load is disconnected from the battery and the capacitor is connected to and charged by the battery. In a second mode, the processor is configured to open the first switch and close the second switch such that the load is powered by the battery and the processor is electrically isolated from the battery and powered by the capacitor.

In some implementations of the exemplary embodiments described above, the capacitor may be or include a thin cell capacitor. In some implementations, the capacitor may be connected in parallel with the processor.

In some implementations of the exemplary embodiments described above, the circuit may include at least one switching device controllable by control signals received from the processor to place the at least one switching device in one of a plurality of configurations. In a first configuration, the at least one switching device may be configured to electrically isolate the high current load from the battery and connect the battery to the capacitor to charge the capacitor. In a second configuration, the at least one switching device may be configured to connect the high current load to the battery and electrically isolate the capacitor and the processor from the battery and the high current load. The processor may be powered by the capacitor, and not the battery, in the second configuration.

In some implementations of the exemplary embodiments described above, the device may include an input mechanism configured to receive an unlock code. The processor may be configured to determine the configuration of the at least one switching device and/or positions of the first and second switches based upon a received unlock code. In some implementations, the device may include a locking mechanism configured to unlock the electronic locking device. The high current load may be a motor that is operably connected to the locking mechanism to unlock the electronic locking device. The processor may be configured to cause the at least one switching device to enter into the second configuration and/or close the second switch when the unlock code is a correct unlock code.

In some implementations of the exemplary embodiments described above, the at least one switching device may be in the second configuration for between 45 milliseconds and 100 milliseconds before returning to the first configuration.

In some implementations of the exemplary embodiments described above, the combined requirements of the processor and the high current load are greater than a capacity of the battery.

### BRIEF DESCRIPTION OF THE DRAWINGS

FIG. 1 is a block diagram of an electronic padlock in accordance with an illustrative implementation.

FIG. 2 is a trace diagram illustrating an electronic circuit without power management.

FIG. 3 is a circuit diagram of a prior art high current need circuit.

FIG. 4 is a circuit diagram of a high current need circuit in accordance with an illustrative implementation.

FIG. 5 is a trace diagram illustrating the use of the high current need circuit in an electronic padlock in accordance with an illustrative implementation.

FIG. 6 is a partial circuit diagram that may be used in the implementation of the circuit illustrated in FIG. 4 in accordance with an illustrative implementation.

The details of one or more implementations of the subject matter described in this specification are set forth in the accompanying drawings and the description below. Other features, aspects, and advantages of the subject matter will become apparent from the description, the drawings, and the claims.

Like reference numbers and designations in the various drawings indicate like elements. Before turning to the detailed description, which describes the exemplary embodiments in detail, it should be understood that the application is not limited to the details or methodology set forth in the description or illustrated in the figures. It should also be understood that the terminology is for the purpose of description only and should not be regarded as limiting.

### DETAILED DESCRIPTION

Various exemplary embodiments described in the present disclosure provide features relating to an electronic locking device that includes an electronic lock mechanism that operates a high current drain motor to lock/unlock the electronic locking device. In some implementations, the electronic locking device can include a coin cell battery, a lower power processor, and a control circuit that allows the coin cell battery to provide power to both the motor and the processor.

Referring generally to the Figures, an electronic locking device is shown and described. The electronic locking device includes a processor for providing logic of the electronic locking device and a high current load (e.g., motorized locking mechanism). The electronic locking device further includes a battery for powering the high current load and a capacitor in parallel with the processor. A circuit of the electronic padlock is configured to cause the processor to be powered by the capacitor (and not the battery) while the battery is driving the high current load. In one illustrative implementation, the electronic locking device is an electronic padlock, such as an electronic combination or keypad padlock. In other illustrative implementations, the electronic locking device may be or include, without limitation, devices such as an electronic door lock or keypad device (e.g., a keypad deadbolt), an electronic safe (e.g., a small document safe, a weapon storage safe, or an electronic keysafe), an electronic rim or mortise lock or other type of cabinet lock, an electronic auto accessory lock (e.g., a coupler lock, a hitch pin lock, a trailer lock, etc.) and/or a steering wheel or door lock for an automobile, a vehicle lock (e.g., a wheel lock or ignition lock) for other motorized or non-motorized vehicles such as a bicycle, a motorcycle, a scooter, an ATV, and/or a snowmobile, a storage chest, a case with an electronic lock (e.g., a document case or a case for small valuables), an electronic cable lock (e.g., a cable lock enabled with an alarm, such as for securing a computing device), a safety lockout/tagout device for securing access for safety purposes (e.g., for securing an electrical control box while electrical work is being performed), a locker with an electronic lock, and/or an electronic luggage lock. In some implementations, an electronic padlock or other locking device may be equipped to be locked or unlocked using another user interface device other than a combination input or keypad input. For example, a wireless communication technology (e.g., radio frequency identification (RFID), WiFi, etc.) may be used to lock/unlock the electronic locking device wirelessly (e.g., a RFID keyfob may be placed in proximity to the locking device to unlock the locking device).

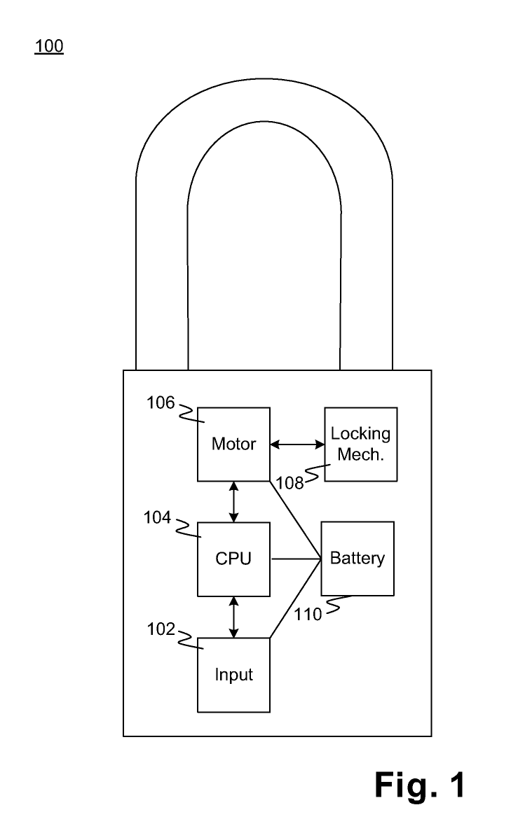

FIG. 1 is a block diagram of an electronic locking device 100 (e.g., an electronic padlock) in accordance with an illustrative implementation. The electronic locking device 100 can include an input mechanism 102. For example the input mechanism can be a keypad, dial(s), biometric devices (e.g., fingerprint scanner), or any other type of input device that can be used to provide an unlock code to the electronic locking device 100. The input mechanism 102 can provide data to a low-power processor 104. In one illustrative embodiment, the low-power processor 104 may have an operating current of approximately 0.15 mA, a sleep current (i.e., a current drawn by the processor 104 when not in an operating state) of approximately 0.001 mA, and a minimum operating voltage of approximately 1.8 V. In one illustrative implementation, the processor may be selected from the Texas Instruments® MSP430 family of low power microprocessors. The processor 104 can determine if a correct unlock code was provided through the input mechanism 102 (e.g., by comparison of the unlock code with a code stored in a memory accessible by the processor 104). If a correct unlock code was provided, the processor 104 can signal a motor 106 to lock/unlock the electronic locking device 100. The motor 106 can be operably connected to a locking mechanism 108 that mechanically locks/unlocks the electronic locking device 100. In one exemplary embodiment, the locking mechanism 108 may include a solenoid valve coupled to a bar or other blocking mechanism configured to prevent a latch of the locking device 100 from being opened until a valid code has been provided via the input mechanism 102. A battery 110 can be operably connected to the processor 104 and the motor 106 to power these components. The battery 110 can also be operably connected to the input mechanism 102 (e.g., an electronic input mechanism, such as an electronic keypad) if needed. In one implementation, the battery 110 can be a thin lithium coin cell. In some exemplary implementations, the lithium coin cell may include a voltage in the range of approximately 500 mV to 3.7 V. In one illustrative implementation, the lithium coin cell may be a CR2032 coin cell. In one illustrative implementation, the coin cell may have a nominal voltage of approximately 3.0 V, a typical pulse current of approximately 10 mA, a capacity of approximately 240 mAh, a typical continuous current of less than approximately 0.05 mA, and/or an internal resistance of approximately 40 ohms. To reduce power requirements and form factor, the processor 104 can be a low-power processor and the battery 110 can be chosen to reduce the size of the internal components of the electronic locking device 100. This may in turn help to reduce the size of the housing and overall size of the electronic locking device 100.

Thin coin cell batteries, e.g., lithium coin cells, have a small form factor and can be integrated as a power source into various devices, e.g., the electronic locking device 100. One issue, however, with coin cell batteries is that they can include a high internal resistance that prohibits high currents from being generated by the coin cell battery. As described below, a lithium coin cell may be unable to provide adequate voltage and current to drive both the processor and a high current load motor of an electronic locking device. Specifically, as the battery is drained slightly, the increased internal resistance of the battery may cause the voltage supplied by the battery to drop. In some implementations, the voltage may drop below a minimum operating voltage required by the microprocessor. Because the microprocessor is controlling the supply of power to the motor (e.g., through the switch), when the microprocessor stops operating correctly due to the voltage drop from the battery, the power supply may be cut off from the motor before the motor can fully complete a lock/unlock operation.

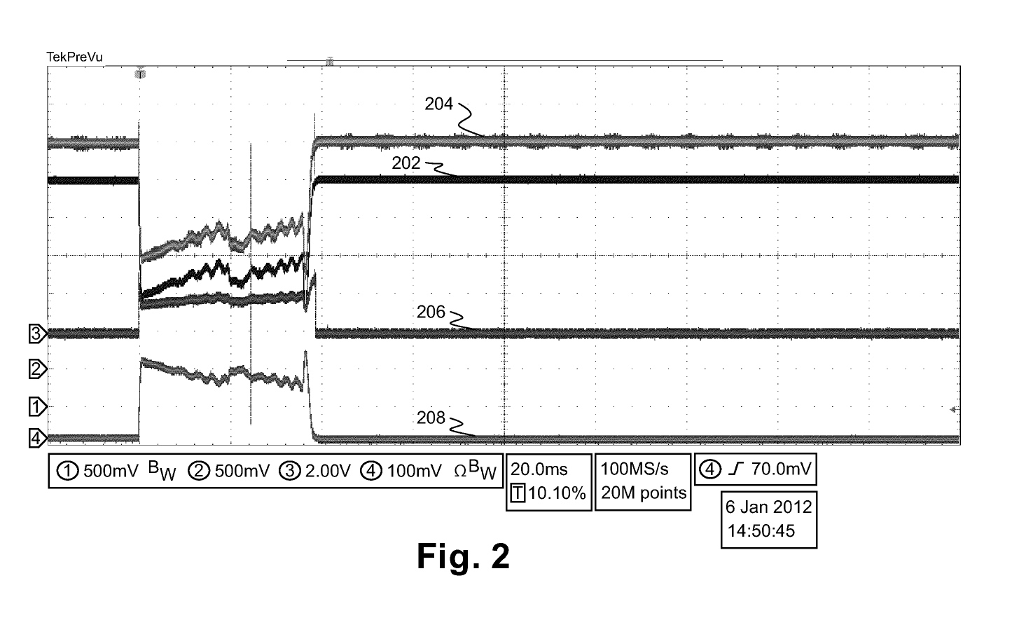

FIG. 2 is a trace diagram illustrating electrical operating conditions associated with an electronic circuit of an electronic locking device (e.g., an electronic padlock) according to one illustrative implementation. In the illustrated implementation, the voltage of the battery is approximately 3.0 V, the low voltage cutoff for the processor is approximately 1.8 V, and the current required by the motor of the locking device is approximately 400 mA. In the illustrated implementation, the motor of the locking device requires a power signal having a pulse width of at least 65 milliseconds (μs) to completely lock or unlock the locking mechanism. In other implementations, the motor may require a different minimum pulse width (e.g., approximately 45 milliseconds to 100 milliseconds). The trace diagram includes a processor voltage trace 202 of the voltage provided to the processor, a battery voltage trace 204 illustrating the voltage of the coin cell battery, a switch control voltage trace 206 illustrating a control signal provided by the processor that controls the switch that pulses the motor, and a battery current trace 208 illustrating the current drawn from the coin cell battery.

The pulse width of the power signal provided from the battery to the motor as illustrated in FIG. 2 is only approximately 40 milliseconds. The pulse width is truncated because the voltage supply to the processor drops below a minimum voltage of 1.8 V required to run the processor due to the high current drawn by the motor. When the voltage falls below the minimum voltage, the switch control voltage signal (see trace 206) from the processor used to control the switch that connects the high current load to the battery is truncated, causing the switch to open, which in turn opens the circuit connecting the battery to the motor. The motor, therefore, only receives an adequate high-current pulse from the battery for a pulse width of 40 milliseconds instead of the full 65 milliseconds needed to complete the lock/unlock operation. The early termination of the pulse from the battery results in the high current load motor being unable to completely lock or unlock the locking mechanism. Although the voltage level during the pulse eventually falls below the processor's minimum required voltage, the supply voltage may be adequate to power the motor to completely lock/unlock the locking mechanism even after the dip in voltage.

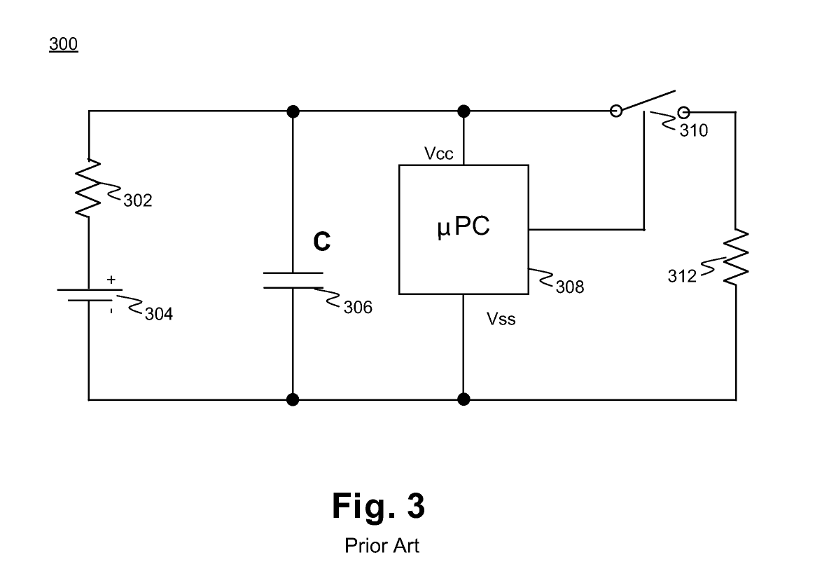

One possible solution for counteracting the drop in voltage in high current drain applications is to include a capacitor that is electrically coupled to the battery, the processor, and the load and configured to supplement the current provided from the battery to power the processor and the load. FIG. 3 is a circuit diagram of one circuit 300 that may be utilized for applications involving high current loads. In the circuit 300, a battery 304 is connected in parallel with a capacitor 306 to a processor 308. The battery 304 includes an internal resistance that is represented schematically in the circuit 300 by a resistor 302. The battery 304 provides operating power to the processor 308 and charges the capacitor 306. A high current load 312 is also connected to the battery 304 in the circuit 300. The high current load 312 can be a motor or any other component that requires a substantially instantaneous, high level of input current. A switch 310 is used to connect and disconnect the high current load 312 from the battery 304. The processor 308 controls the operation of the switch 310 by sending control signals to the switch 310 to close the switch, connecting the load 312 to the battery 304, and open the switch, disconnecting the load 312 from the battery 304.

When the switch 310 is in the open position, the battery 304 charges the capacitor 306. The capacitor 306 may continue to be charged by the battery 304 until the switch 310 is opened or the capacitor 306 is fully charged to a maximum capacity. When the processor 308 closes the switch 310, the high current load 312 is connected to the battery 304 and a high input current is drawn into the load 312. Current may be drawn to the load 312 from both the battery 304 and the capacitor 306. The capacitor 306 may be selected such that it is capable of providing the large, relatively instantaneous current required by the load 312 and a large current level does not need to be pulled from the battery 304, allowing the battery 304 to maintain a more stable voltage level than if the capacitor 306 were not present. The load 312 may complete an operation, such as locking/unlocking a latch of an electronic locking device, and the processor 308 may be configured to open the switch 310 and disconnect the load 312 from the battery 304 and capacitor 306 (e.g., after the processor 308 receives an input signal indicating that the operation has been completed and/or after passage of a predetermined amount of time).

In the implementation illustrated in FIG. 3, the capacitor 306 may be large and expensive. In some implementations, the size and/or expense of the capacitor may make inclusion of the capacitor within an electronic padlock or other small electronic device impractical. In one illustrative implementation, such as an implementation in which the load draws a peak current of approximately 30 mA, a 100 pF capacitor may be used. In higher current implementations, such as a motor for locking/unlocking a padlock or other access control device, the peak current draw may be substantially higher (e.g., approximately 300-400 mA). In such implementations, the capacitor in the implementation illustrated in FIG. 3 may be very large (e.g., a supercapacitor having a capacitance of approximately 1 F or larger).

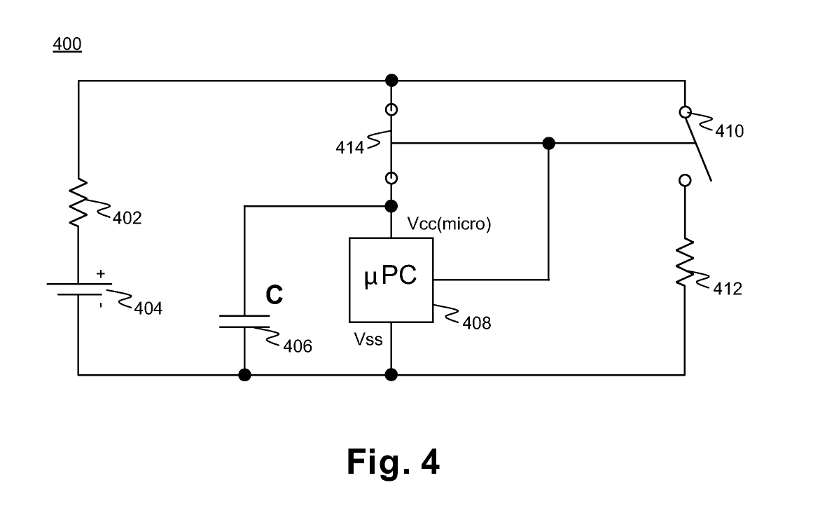

FIG. 4 illustrates a circuit diagram of a circuit 400 configured to drive a high current load in accordance with an exemplary embodiment of the invention. A battery 404 having an internal resistance represented by resistor 402 is electrically connected to a processor 408 and a capacitor 406. The battery 404 is connected through a first switch 410 to a high current load 412 such as a motor. A second switch 414 is configured to connect and disconnect the processor 408 and capacitor 406 from the battery 404.

The processor 408 controls the position of the switches 410 and 414 using one or more switch control signals. In one implementation, the switches 410 and 414 may be controlled by a single control signal from the processor 408 and are always in opposite positions (i.e., when the switch 410 is open, the switch 414 is closed, and vice versa). When the switch 414 is closed and the switch 410 is open, the battery 404 provides power to the processor 408 and charges the capacitor 406. When the processor 408 closes the switch 410 and opens the switch 414, the high current load 412 is electrically coupled to the battery 404 and a high input current is drawn from the battery 404 to the load 412. In this configuration, the processor 408 and the capacitor 406 are electrically isolated from the load 412 by the open switch 414 and the capacitor 406 powers only the processor 408. The voltage across the battery 404 may drop due to the high current drawn to the load 412, but the voltage may remain above a minimum operating voltage of the load 412. Because the processor 408 is powered by the capacitor 406 and not the battery 404 in this configuration, the drop in voltage at the battery 404 does not affect operation of the processor 408 and does not cause the switch control signal to be truncated. Because the capacitor 406 is dedicated to provide power only to the processor 408 (e.g., a low current processor), the capacitor 406 can be a substantially smaller and less expensive capacitor than the capacitor in the illustrative implementation shown in FIG. 3 while still being large enough to power the microprocessor for the entire required duration of the motor pulse. In some implementations, the capacitor 406 may have a capacitance in a range of 10 pF to 100 pF. In one implementation, the capacitor may have a capacitance of approximately 22 pF. In another implementation, the capacitor may have a capacitance of approximately 40 pF. The processor 408 may open the switch 410 and close the switch 414 (e.g., once a load operation, such as a lock/unlock operation, has been completed) to disconnect the load 412 from the battery 404 and connect the processor 408 and the capacitor 406 to the battery 404. The capacitor 406 may then be recharged by the battery 404.

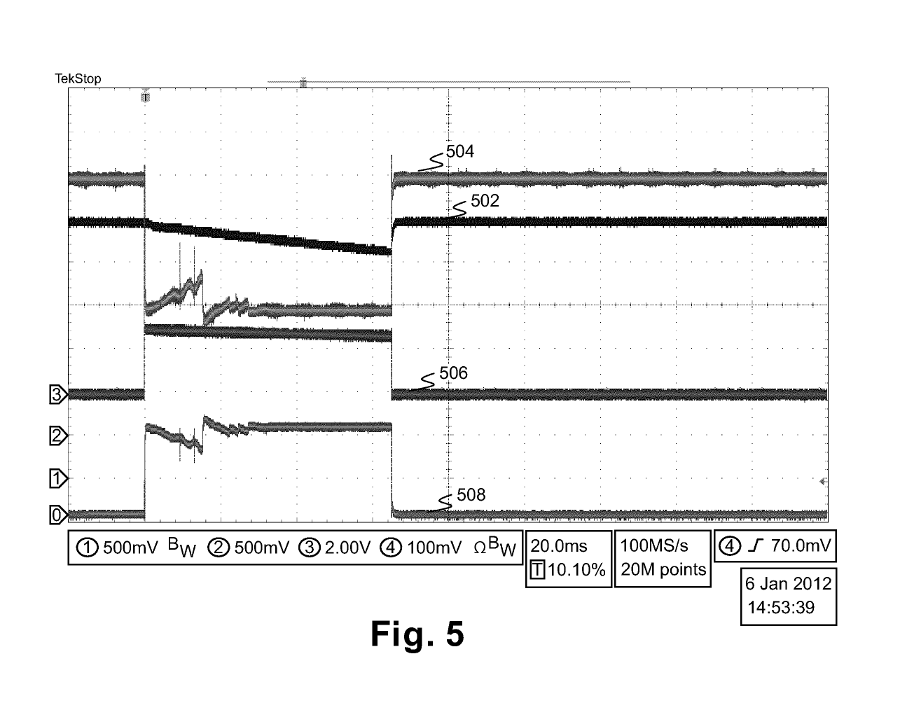

FIG. 5 is a trace diagram illustrating the use of the circuit 400 in an electronic locking device (e.g., an electronic padlock) in accordance with an illustrative implementation. The trace diagram includes a processor voltage trace 502 of the voltage provided to the processor, a battery voltage trace 504 illustrating the voltage of the coin cell battery, a switch control trace 506 illustrating a control signal from the processor that controls the switches, and a battery current trace 508 illustrating the current drawn from the coin cell battery. In contrast with the trace diagram of FIG. 2, the pulse width of the signals illustrated in FIG. 5 are the full 65 μs required by the motor to lock/unlock the locking device latch. As shown in FIG. 5, the operating voltage at the processor provided by the capacitor remains above the minimum required voltage of the processor for the entirety of the motor pulse duration (see trace 502). Accordingly, the processor operates throughout the duration of the motor pulse. In addition, the battery provides the required high level of current to the high current load.

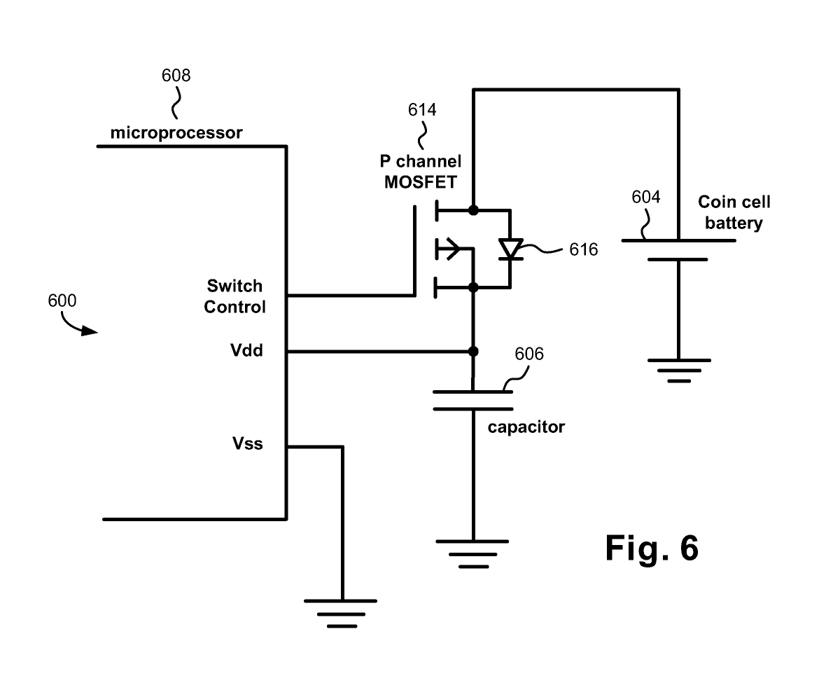

Referring now to FIG. 6, an example partial circuit diagram of a circuit 600 is shown in according with an illustrative implementation. In some implementations, components such as those shown in the circuit 600 may be utilized in the implementation of a circuit similar to the circuit 400 shown in FIG. 4. The circuit 600 includes a processor 608, a battery 604, and a capacitor 606. The processor 608 and capacitor 606 are connected to the battery 604 through a switch 614. In the illustrated implementation, the switch 614 is a p-channel metal-oxide semiconductor field-effect transistor (MOSFET), which may be referred to as a pMOS transistor. The battery 604 is connected to a drain terminal of the MOSFET, and the positive power terminal of the processor 608 as well as the high voltage side of the capacitor 606 are connected to the source terminal of the MOSFET. Connecting the drain terminal of the MOSFET to the battery 604 and the source terminal to the processor 608 and capacitor 606 prevents the capacitor 606 from discharging when the MOSFET is switched off and allows the capacitor 606 to be charged by the battery 604 when the MOSFET is in an undetermined state. The negative, or ground, terminal of the processor 608 as well as the low voltage side of the capacitor 606 are connected to ground. The body terminal of the MOSFET is connected to the source terminal.

The processor 608 is configured to transmit a switch control signal used to control the operation of the MOSFET. The switch control signal is normally low, and the battery 604 is connected to the processor 608 and the capacitor 606 (e.g., to charge the capacitor 606) when the switch control signal is low. When the switch control signal is high (e.g., above a predetermined voltage level), the lock motor (not illustrated) actuates, and the MOSFET disconnects the processor 608 and the capacitor 606 from the battery 604, such that only the battery 604 provides power to the motor and only the capacitor 606 provides power to the processor 608. The lock motor may be connected in parallel to the processor 608 and capacitor 606, such that a high voltage terminal of the motor may be connected to the high voltage side of the battery 604 and a low voltage terminal of the motor may be connected to ground. The lock motor may be connected through another switch (e.g., a MOSFET switch) controlled by the processor 608, and the motor switch may be controlled in a manner such that, when the switch 614 is closed, the lock switch is open, and when the switch 614 is open, the lock switch is closed. The source terminal of the MOSFET is coupled to the drain terminal through a body diode 616. The body diode 616 allows the capacitor to charge at initial battery installation and blocks the capacitor current from traveling through the source terminal of the MOSFET to the drain terminal and to the lock motor when the MOSFET switch is open.

Various illustrative implementations are described above with reference to an electronic padlock. It should be appreciated that, in some implementations, the device may be or include any type of electronic locking device and is not limited to an electronic padlock. For example, in various illustrative implementations the electronic locking device may include, but is not limited to, an electronic door lock or keypad device (e.g., a keypad deadbolt), an electronic safe (e.g., a small document safe, a weapon storage safe, or an electronic keysafe), an electronic rim or mortise lock or other type of cabinet lock, an electronic auto accessory lock (e.g., a coupler lock, a hitch pin lock, a trailer lock, etc.) and/or a steering wheel lock for an automobile, a vehicle lock (e.g., a wheel lock or ignition lock) for other motorized or non-motorized vehicles such as a bicycle, a motorcycle, a scooter, an ATV, and/or a snowmobile, a storage chest, a case with an electronic lock (e.g., a document case or a case for small valuables), an electronic cable lock (e.g., a cable lock enabled with an alarm, such as for securing a computing device), a safety lockout/tagout device for securing access for safety purposes (e.g., for securing an electrical control box while electrical work is being performed), a locker with an electronic lock, and/or an electronic luggage lock.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media (e.g., tangible and/or non-transitory) for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, flash memory, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. An electronic locking device comprising:
a circuit configured to cause a processor of the electronic locking device to be powered by a capacitor, and not a battery for powering a high current load of the electronic locking device, while the battery is driving the high current load of the electronic locking device.

2. The electronic locking device of claim 1, wherein the capacitor comprises a thin cell capacitor.

3. The electronic locking device of claim 1, wherein the capacitor is connected in parallel with the processor.

4. The electronic locking device of claim 1, wherein the circuit comprises at least one switching device controllable by control signals received from the processor to place the at least one switching device in one of a plurality of configurations, wherein, in a first configuration, the at least one switching device is configured to electrically isolate the high current load from the battery and connect the battery to the capacitor to charge the capacitor, and wherein, in a second configuration, the at least one switching device is configured to connect the high current load to the battery and electrically isolate the capacitor and the processor from the battery and the high current load, wherein the processor is powered by the capacitor, and not the battery, in the second configuration.

5. The electronic locking device of claim 4, further comprising an input mechanism configured to receive an unlock code, wherein the processor is configured to determine the configuration of the at least one switching device based upon a received unlock code.

6. The electronic locking device of claim 5, further comprising a locking mechanism configured to unlock the electronic locking device, wherein the high current load is a motor and the motor is operably connected to the locking mechanism to unlock the electronic locking device, and wherein the processor is configured to cause the at least one switching device to enter into the second configuration when the unlock code is a correct unlock code.

7. The electronic locking device of claim 4, wherein the at least one switching device is in the second configuration for between 45 milliseconds and 100 milliseconds before returning to the first configuration.

8. The electronic locking device of claim 1, wherein combined requirements of the processor and the high current load are greater than a capacity of the battery.

9. An electronic locking device comprising:
a battery;
a processor;
a capacitor that is electrically coupled to the processor;
a load; and
at least one switching device, wherein the at least one switching device is controllable by control signals received from the processor to place the at least one switching device in one of a plurality of configurations,
wherein, in a first configuration, the at least one switching device is configured to electrically isolate the load from the battery and connect the battery to the capacitor to charge the capacitor, and
wherein, in a second configuration, the at least one switching device is configured to connect the load to the battery and electrically isolate the capacitor and the processor from the battery and the load, wherein the processor is powered by the capacitor in the second configuration.

10. The electronic locking device of claim 9, wherein the capacitor comprises a thin cell capacitor.

11. The electronic locking device of claim 9, wherein the capacitor is connected in parallel with the processor.

12. The electronic locking device of claim 9, further comprising an input mechanism configured to receive an unlock code, wherein the processor is configured to determine the configuration of the at least one switching device based upon a received unlock code.

13. The electronic locking device of claim 12, further comprising a locking mechanism configured to unlock the electronic locking device, wherein the load is a motor and the motor is operably connected to the locking mechanism to unlock the electronic locking device, and wherein the processor is configured to cause the at least one switching device to enter into the second configuration when the unlock code is a correct unlock code.

14. The electronic locking device of claim 9, wherein the at least one switching device is in the second configuration for between 45 milliseconds and 100 milliseconds before returning to the first configuration.

15. The electronic locking device of claim 9, wherein combined requirements of the processor and the high current load are greater than a capacity of the battery.

16. An electronic locking device comprising:
a battery;
a processor configured to control a position of a first switch and a position of a second switch;
a capacitor, wherein the capacitor is connected in parallel with the processor;
a high current load;
the first switch configured to:
connect, in a closed position, the battery to the capacitor and the processor, wherein the battery provides power to the processor and the capacitor when the first switch is in the closed position; and
disconnect, in an open position, the battery from the capacitor and the processor, wherein the capacitor is configured to provide power to the processor when the first switch is the open position; and
the second switch configured to:
connect, in a closed position, the battery to the high current load, wherein the battery provides power to the high current load when the second switch is in the closed position; and
disconnect, in an open position, the battery from the high current load.

17. The electronic locking device of claim 16, wherein the first switch is in an opposite position compared to the second switch.

18. The electronic locking device of claim 16, further comprising an input mechanism configured to receive an unlock code, wherein the processor is configured to determine the positions of the first switch and the second switch based upon a received unlock code.

19. The electronic locking device of claim 18, further comprising a locking mechanism configured to unlock the electronic locking device, wherein the high current load is a motor, wherein the processor is configured to close the second switch if the unlock code is a correct unlock code, and wherein the motor is operably connected to the locking mechanism to unlock the electronic locking device.

20. The electronic locking device of claim 16, wherein combined requirements of the processor and the high current load are greater than the capacity of the battery.
